(19) United States
(12) Patent Application Publication
(10) Pub. No.: US 2020/0082405 A1
(43) Pub. Date: Mar. 12, 2020

(54) METHOD AND SYSTEM FOR CLIENT SUPPORT IN A BLOCKCHAIN NETWORK

(71) Applicant: NEC Laboratories Europe GmbH, Heidelberg (DE)

(72) Inventors: Wenting Li, Heidelberg (DE); Ghassan Karame, Heidelberg (DE)

(21) Appl. No.: 16/128,569

(22) Filed: Sep. 12, 2018

(51) Int. Cl. G06Q 20/40; G06Q 20/22; H04L 9/06

(52) U.S. Cl. CPC G06Q 20/407; G06Q 20/29; H04L 2209/38; H04L 9/0643; H04L 9/0637

(57) ABSTRACT

A method for supporting transaction forwarding to a thin client of a blockchain network performed by a node of the blockchain network includes: receiving a refund transaction from the thin client, the refund transaction having a service bootstrap fee; determining whether to provide transaction forwarding support to the thin client in response to receiving the refund transaction; based upon determining to provide transaction forwarding support, signing the refund transaction and sending the signed refund transaction to the thin client to establish a micropayment channel; receiving a transaction filter from the thin client; locating a blockchain transaction from a blockchain ledger and its corresponding proof that it is included in the ledger; sending the located blockchain transaction and the corresponding proof to the thin client; and receiving an update transaction from the thin client, the update transaction comprising an updated service fee and being signed by the thin client.

### FIELD

The present invention relates to a method and system for client support in a blockchain network.

### BACKGROUND

Blockchain systems are a type of distributed database management systems that allow for data (e.g., a digital ledger including transactions and metadata) to be securely and reliably recorded, shared, and synchronized across a distributed network of different network participants (e.g., nodes). Blockchain technology uses a particular type of data structure that facilitates the storage and distribution of data in packages called “blocks” that are digitally connected to each other in a “chain.” Blockchain systems provide a decentralized, open, Byzantine fault-tolerant transaction mechanism.

Blockchain systems are becoming common for various types of Internet interactions, including anonymous online payments, remittance, and the transaction of digital assets (e.g., digital currencies). Cryptocurrencies (a type of digital currency), such as those provided by the Bitcoin, Litecoin, Dogecoin, or Ethereum platforms, are well-recognized examples of blockchain systems.

Thin client support is an open issue in current blockchain implementations. Thin clients run on devices with constrained resources, including CPU, storage, and bandwidth. These clients neither download nor process the whole blockchain. Instead, they rely on full nodes to verify and forward the transactions related to the thin client users. However, since all blockchain nodes join the network voluntarily, there is no special support from the blockchain to provide this transaction forwarding service to the thin clients. In fact, to have such kind of support, the full nodes have to fetch the whole blockchain from disk, and filter it upon each thin client's request. Currently, such effort by the full nodes is not compensated by the thin clients. Therefore, there is no incentive for the full nodes to support thin clients in the network.

SmartLight (see Damian Gruber, Wenting Li, Ghassan Karame, “Unifying Lightweight Blockchain Client Implementations,” In Proceedings of the NDSS Workshop on Decentralized IoT Security and Standards (NDSS-DISS), San Diego, Calif., USA, 2018, the entire contents of which are hereby incorporated by reference herein) is a scheme to reward serving nodes by striking a smart contract between the thin client and the serving full nodes. For each forwarded transaction, the serving node is expecting a payment acknowledgement with the thin client's signature, which can then be used by the serving node to redeem his reward from the contract. However, this solution only works with blockchains that support arbitrary smart contracts such as Ethereum. There are still many blockchain systems that are based on the bitcoin protocol that do not support such smart contract schemes. For such blockchain systems, each payment acknowledgement would be a micropayment transaction (i.e., transactions that happens frequently and only involves a small amount of value) that the serving node needs to submit to the network in order to claim the service fees. However, given the restricted processing and storage capabilities, the blockchain network discourages such micropayment transactions by increasing the transaction fees.

### SUMMARY

An embodiment of the present invention provides a method for supporting transaction forwarding to a thin client of a blockchain network performed by a node of the blockchain network that includes: receiving a refund transaction from the thin client, the refund transaction having a service bootstrap fee; determining whether to provide transaction forwarding support to the thin client in response to receiving the refund transaction; based upon determining to provide transaction forwarding support to the thin client, signing the refund transaction and sending the signed refund transaction to the thin client to establish a micropayment channel; receiving a transaction filter from the thin client; locating a blockchain transaction from a blockchain ledger and its corresponding proof that it is included in the ledger; sending the located blockchain transaction and the corresponding proof to the thin client; and receiving an update transaction from the thin client, the update transaction comprising an updated service fee and being signed by the thin client.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a blockchain network;

FIG. 2 illustrates a blockchain system having transaction forwarding with payment channels according to an embodiment;

FIG. 3 illustrates a method for supporting thin clients in a blockchain network according to an embodiment; and

FIG. 4 illustrates a processing system according to an embodiment of the present invention.

### DETAILED DESCRIPTION

A problem unique to computer implemented blockchain systems, and solved by embodiments of the present invention, is how to effectively support thin clients on a blockchain network. To solve the problem, embodiments provide micropayment channels with the transaction forwarding service to guarantee a fair payment process between the thin clients and the serving full nodes. Enabling fair payment incentivizes the full nodes to support the thin clients in the blockchain network (particularly where no alternative transaction scheme is available—e.g., in systems without an available smart contract scheme). An additional advantage of embodiments of the present invention is that the payment for each forwarded transaction does not increase the workload of the blockchain. For example, full nodes can be rewarded in batch by only two transactions: the setup transaction and the last update transaction, which closes the payment channel.

According to an embodiment of the present invention, a full node accepts the service request by accepting the payment channel establishment. For each forwarded transaction, an update transaction is acknowledged by the thin client, which updates the balances of the thin client and the serving full node frequently without giving extra workload to the blockchain network. Transaction protocols of the present invention also guarantee that either the thin client or the full node can cancel the service at any time and the full node can claim the reward for what has been served.

An embodiment of the present invention provides a method for supporting transaction forwarding to a thin client of a blockchain network performed by a node of the blockchain network that includes: receiving a refund transaction from the thin client, the refund transaction having a service bootstrap fee; determining whether to provide transaction forwarding support to the thin client in response to receiving the refund transaction; based upon determining to provide transaction forwarding support to the thin client, signing the refund transaction and sending the signed refund transaction to the thin client to establish a micropayment channel; receiving a transaction filter from the thin client; locating a blockchain transaction from a blockchain ledger and its corresponding proof that it is included in the ledger; sending the located blockchain transaction and the corresponding proof to the thin client; and receiving an update transaction from the thin client, the update transaction comprising an updated service fee and being signed by the thin client.

In an embodiment, the update transaction is one of a plurality of update transactions received from the thin client, each being received individually and successively. Also, each of the update transactions may increase the updated service fee over a prior updated service fee. The method may further include, in response to receiving each of the update transactions, locating, and sending to the thin client, another blockchain transaction from the blockchain ledger and its corresponding proof that it is included in the ledger.

In an embodiment, the method further includes: determining whether to close the micropayment channel and to stop supporting transaction forwarding; based upon determining to close the micropayment channel and to stop supporting transaction forwarding, signing and publishing a most recently received one of the update transactions; and collecting the updated service fee corresponding to the signed and published one of the update transactions.

The refund transaction can be signed by the thin client, can be created based upon having a setup transaction as an input, and can have as its outputs the service bootstrap fee for the node and a remaining deposit for the thin client.

In an embodiment, the method further includes receiving the setup transaction as a published transaction on the blockchain network, the setup transaction being received after sending the signed refund transaction to the thin client.

The setup transaction can be created based upon having a deposit from the thin client as an input, and the setup transaction can have as an output a multi-signature of the thin client and the node.

The update transaction can be created based upon having the setup transaction as an input, and can have as its output the updated service fee for the node and an updated remaining deposit for the thin client. Also, the updated service fee may include the service bootstrap service fee and a multiple of a single transaction forwarding fee.

In an embodiment, the refund transaction has a time lock, and the method further includes: determining whether the time lock has expired; upon determining that the time lock has expired, closing the micropayment channel and stopping support of transaction forwarding.

In an embodiment, the method further includes receiving a rating on performance of transaction forwarding support.

Another embodiment of the present invention provides a node of a blockchain network that has a processor and a memory. The memory contains processor executable instructions that, when executed by the processor, cause the processor to perform the following operations for supporting transaction forwarding to a thin client: receiving a refund transaction from the thin client, the refund transaction including a service bootstrap fee; determining whether to provide transaction forwarding support to the thin client in response to receiving the refund transaction; based upon determining to provide transaction forwarding support to the thin client, signing the refund transaction and sending the signed refund transaction to the thin client to establish a micropayment channel; receiving a transaction filter from the thin client; locating a blockchain transaction from a blockchain ledger and its corresponding proof that it is included in the ledger; sending the located blockchain transaction and the corresponding proof to the thin client; and receiving an update transaction from the thin client, the update transaction including an updated service fee and being signed by the thin client.

The update transaction can be one of a plurality of update transactions individually and successively receivable from the thin client. Also, each of the update transactions can be configured to increase the updated service fee over a prior updated service fee. The processor executable instructions, when executed by the processor, may further cause the processor to perform the following operations: in response to receiving each of the update transactions, locating, and sending to the thin client, another blockchain transaction from the blockchain ledger and its corresponding proof that it is included in the ledger.

In an embodiment, the processor executable instructions, when executed by the processor, further cause the processor to perform the following operations: determining whether to close the micropayment channel and to stop supporting transaction forwarding; based upon determining to close the micropayment channel and to stop supporting transaction forwarding, signing and publishing a most recently received one of the update transactions; and collecting the updated service fee corresponding to the signed and published one of the update transactions.

The refund transaction can be signed by the thin client, and can be created based upon having a setup transaction as an input, and can have as its outputs the service bootstrap fee for the node and a remaining deposit for the thin client.

Another embodiment of the present invention provides a non-transitory computer readable medium storing processor executable instructions that, when executed by a processor, cause the processor to perform the following operations for supporting transaction forwarding to a thin client: receiving a refund transaction from the thin client, the refund transaction including a service bootstrap fee; determining whether to provide transaction forwarding support to the thin client in response to receiving the refund transaction; based upon determining to provide transaction forwarding support to the thin client, signing the refund transaction and sending the signed refund transaction to the thin client to establish a micropayment channel; receiving a transaction filter from the thin client; locating a blockchain transaction from a blockchain ledger and its corresponding proof that it is included in the ledger; sending the located blockchain transaction and the corresponding proof to the thin client; and receiving an update transaction from the thin client, the update transaction including an updated service fee and being signed by the thin client.

The update transaction can be one of a plurality of update transactions individually and successively receivable from the thin client. Also, each of the update transactions can be configured to increase the updated service fee over a prior updated service fee, and the processor executable instructions, when executed by the processor, can further cause the processor to perform the following operations: in response to receiving each of the update transactions, locating, and sending to the thin client, another blockchain transaction from the blockchain ledger and its corresponding proof that it is included in the ledger.

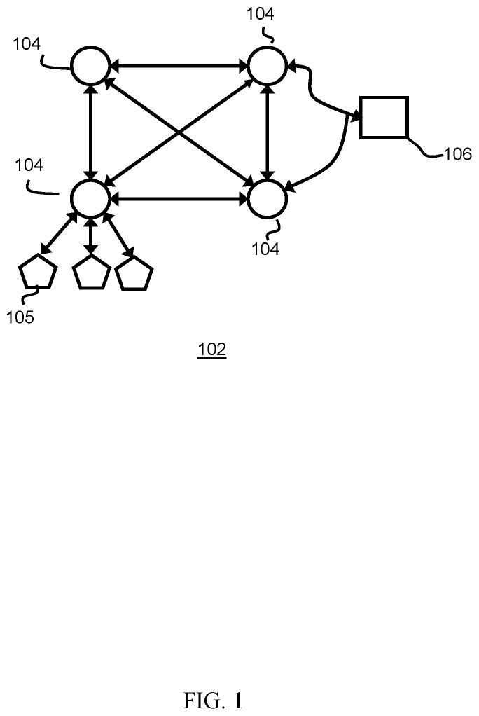

FIG. 1 illustrates a blockchain network according to an embodiment of the present invention. The blockchain network 102 is based on a peer-to-peer network where all nodes are running a blockchain client. Any node can issue a signed transaction where the signature is verifiably linked to his account information. Upon reception of a transaction message, some nodes are able to verify the transaction based on the blockchain data stored locally. Then the verified transaction is included in a transaction pool, from which some of the transactions are grouped into a block and proposed into the network. Upon reception of a block, some nodes verify the block and append it to the locally stored blockchain if accepted.

Blockchain nodes generally can be classified into three types of nodes: full nodes 104, mining nodes 105, and thin clients (lightweight nodes) 106. The blockchain nodes exchange blockchain data over the blockchain network 102. Blockchain data includes blockchain blocks and proposed transactions.

Full nodes 104 run the full block chain protocol, which requires that the node stores and maintains the complete blockchain data and validates received transactions and blocks. Full nodes 104 validate transactions and blocks according to the blockchain consensus algorithm. The consensus protocol may include a proof of work algorithm. Full nodes 104 also provide various services to other blockchain network nodes. For example, full nodes 104 may filter transactions and blocks on behalf of thin clients 106 so that the thin clients 106 do not need to download all transactions to find their own transactions; transmit new transactions from thin clients 106 to other nodes (e.g., other full nodes 104, mining nodes 105, or other thin clients 106); broadcast new blocks to other nodes (e.g. mining nodes 105 or other full nodes 104); and/or find and forward requested transactions to a thin client 106. In general, running a full node 104 can be resource intensive.

Mining nodes 105 take part in the consensus protocol to generate new blocks, but do not necessarily perform the full blockchain protocol (e.g., may not provide all the services of a full node 104). Mining nodes may be part of a mining pool, which is controlled by a full node 104 acting as a pool operator (as shown in FIG. 1). However, mining nodes are not necessarily part of mining pools, and may be direct participants of the blockchain network 102.

Thin clients 106 participate in the blockchain network 102, but generally perform only a small subset of the blockchain protocol. For example, thin clients 106 may only maintain wallets (i.e., their accounts information and cryptocoins) and listen to the network for transactions and/or blocks that they are interested in (e.g., related to their own accounts or transactions). By performing less than the entire blockchain protocol, thin clients 106 avoid the resource intensive aspects associated with full nodes 104 and mining nodes 105 (e.g., they do not need to store the entire block chain or perform the proof-of-work algorithm). Accordingly, thin clients 106 are able to be operated economically and/or on less powerful devices, such as mobile devices.

However, because thin clients 106 do not perform the entire blockchain protocol, they rely on services provided by other nodes. For example, in order to confirm that a certain type of transactions are finalized in the blockchain (e.g., the blockchain ledger), the thin client 106 requests a full node 104 to forward transactions that match relevant criteria, along with proofs that the transactions are included in the blockchain. In conventional systems, the full node 104 providing such services is not compensated by the thin client 106. Therefore, there is no incentive for the full nodes 104 to support thin clients 106 in the blockchain network 102, which leads to the problem of fewer nodes supporting the thin clients 106, and thus limits the effectiveness of the blockchain network 102.

To overcome this problem of a lack of support to thin clients 106, embodiments of the present invention include a transaction forwarding protocol that includes a micropayment. Blockchain systems that implement such micropayments can provide a fair payment scheme to compensate the full nodes 104 that support the thin clients 106. Accordingly, full nodes 104 are incentivized to support the thin clients, thus solving the problem of insufficient support.

Embodiments of the present invention may operate under an unspent transaction output (UTXO) model. In embodiments, the serving full nodes 104 implement a rational scheme to achieve fair payment.

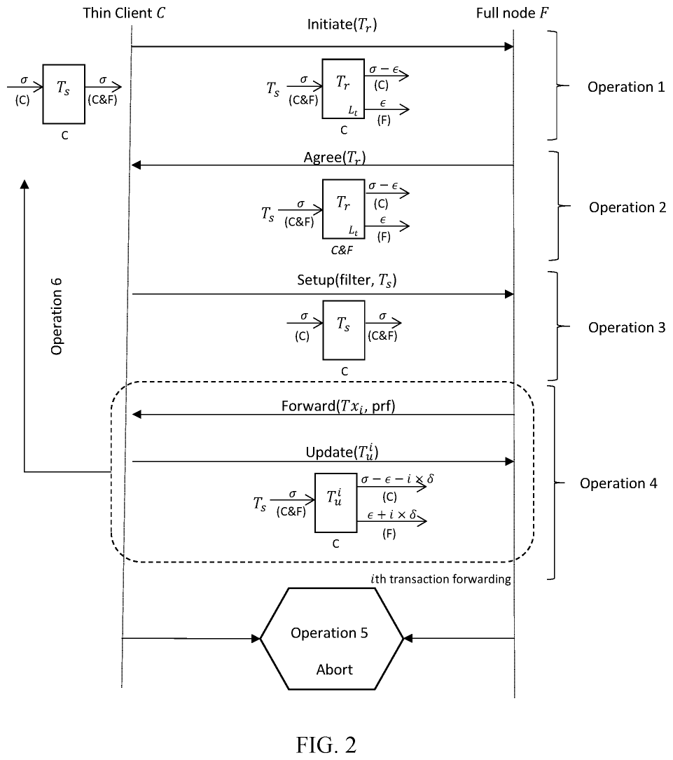

FIG. 2 illustrates a blockchain system that extends the blockchain protocol to include a transaction forwarding scheme that has a micropayment payment channel to guarantee fair payment without giving extra workload to the blockchain network. This blockchain system ensures that thin clients of the blockchain network are supported by incentivizing the full nodes to provide the required support services.

In FIG. 2, each box represents a transaction T, such as a setup transaction Tₛ, a refund transaction Tᵣ, or an update transaction Tₛ.

The arrow on the left side of a transaction box defines a transaction input. For the input arrow, the amount of the input is specified above the arrow, and the claiming condition (e.g., a signature) is below the arrow. The input may be in the form of a hash, e.g., the hash of a previous transaction. The arrow on the right side of a transaction box defines the transaction output. Similar to the input arrow, an amount is specified above the arrow, and an claiming condition below. A transaction may have multiple outputs, and thus, multiple output arrows with an associated amount and claiming condition. The output of a transaction may be in the form of a hash.

A transaction is signed by an account U if the account U is specified under the transaction box. In embodiments, the signing account U may be one or both of the thin client C and the full node F.

If a transaction has a time lock for duration t, Lₜ is specified inside the transaction box.

In what follows, an example embodiment of a protocol to reach an agreement for a transaction forwarding service is described in detail.

In a first operation, the thin client C initiates establishment of a micropayment channel with a full node F.

In the embodiment shown in FIG. 2, the thin client C initiates the establishment of the micropayment channel by initializing a setup transaction Tₛ and sending a refund transaction Tᵣ to the full node F.

The setup transaction Tₛ takes the thin client's deposit σ as an input and outputs a signature to the full node F. For example, the setup transaction Tₛ may output a 2-out-of-2 multi-signature of the thin client and the full node (C&F). By using a multi-signature, cooperation of all parties associated with a multi-signature are required; that is, more than one key is required to authorize a blockchain transaction. A 2-out-of-2 multi-signature requires both keys of the corresponding pair of entities to authorize a blockchain transaction. In the embodiment of FIG. 2, this means that the thin client C's key and the full node F's key are required to authorize the transaction.

The refund transaction Tᵣ takes the setup transaction Tₛ as an input. The setup transaction may be provided as hash of the setup transaction Tₛ. The refund transaction Tᵣ outputs a service bootstrap fee E to the full node F and outputs a remainder of the deposit σ-∈ back to the thin client F. In an embodiment, the refund transaction Tᵣ is a UTXO transaction, which has as its input a corresponding output of a previously confirmed transaction. In an embodiment, to specify the input for the UTXO refund transaction Tᵣ, the following information is provided: (1) the hash of the previously confirmed transaction; (2) the output index that should be used as the input (it should be noted that a transaction can have multiple outputs); and the intended amount that should be used for the input. Accordingly, in an embodiment, where the input of the refund transaction Tᵣ corresponds to the setup transaction Tₛ, (Hash(Tₛ),0,σ) is the input entry of Tᵣ. The service bootstrap fee E may be a small amount of the deposit σ. For example, less than 10%, and preferably 5% to 0.1% of the deposit σ. The bootstrap fee E can be the same amount as the reward S of forwarding one transaction.

In an embodiment, the bootstrap fee E may be a tunable parameter of the blockchain protocol such that the fee percentage may be increased or decreased to effect a match between the supply of full nodes performing services for thin clients with the demand of those services by the thin clients. Alternatively or additionally, the thin client C may adjust the fee percentage in order to incentivize a full node F to provide its services to the thin client C or to ensure that it receives priority service over other thin client requests offering lesser or no bootstrap fee E.

The bootstrap fee E may be used to prevent a thin client C from dropping a connection to a full node F without paying for the last received transaction. Without the bootstrap fee E, a malicious client could get all transactions for free by connecting to multiple full nodes F, and then closing the connection immediately after receiving the first transaction. On the other hand, because a thin client C may connect to multiple full nodes F to get the requested transactions, embodiments provide for a rating system where a malicious full node F that refuses to serve or provides invalid transaction proofs will get a bad rating. A full node F with a sufficiently poor rating may be kicked off the blockchain network, or a thin client C may set a minimum rating necessary for a full node F to collect a fee. Accordingly, because poor behavior will result in bad ratings in exchange for a very small fee, it is not rational for a full node F to misbehave. Therefore, embodiments of the present invention ensure nodes will behave because nodes should operate rationally.

The refund transaction Tᵣ may output the remainder of the deposit σ-∈ back to the thin client F with a time lock Lₜ. The time lock Lₜ specifies to the blockchain that the refund transaction Tᵣ will only be valid after a certain amount of time t. By using a time lock Lₜ, the thin client C creates an incentive for a full node to timely provide services to it, additionally the time lock can provide an automatic timeout mechanism so that the thin client does not pay for late or untimely services.

The refund transaction Tᵣ is pre-signed by the thin client C.

In the second operation, a full node F determines whether to provide services to the thin client C and proceeds based on that determination.

The full node F may determine to provide services to the thin client based on at least one of the service bootstrap fee E and the time lock Lₜ. For example, the full node F may have a minimum required service bootstrap fee E necessary for it to provide services to a thin client C. The full node F may also check the time lock Lₜ to determine whether or not it can provide timely services, and if cannot provide timely service decline to offer such services. The full node F may also determine whether or not to provide services based on its current operational load. For example, it may decline services if it is already operating at a high load.

If the full node F agrees to serve the thin client C, it replies by signing the refund transaction Tᵣ and sending the signed refund transaction Tᵣ back to the thin client C. In an embodiment, the full node signs the refund transaction Tᵣ (e.g., its hash) with its secure key. In an embodiment, the full node may reply with only its secure signature.

If the full node F does not agree to serve the thin client C, the deposit σ is not blocked by the full node F, nor can it claim the service bootstrap fee E, since the setup transaction is not published. Thus, another full node F is free to serve the thin client C.

In a third operation, in response to receiving the signed refund transaction Tᵣ from the full node F, the thin client C sets up the transaction forwarding criteria and publishes the setup transaction Tₛ.

The thin client C may set-up the transaction forwarding criteria by sending a privacy-preserving filter to the full node F. The privacy-preserving filter can be used by the full node F to filter the transactions on behalf of the thin client. In an embodiment, the privacy-preserving filter is a data structure D along with a pre-defined Boolean function Test(D,x) on any input x. The data structure D is prepared by the client C through a construction function D=Build(P), where P is a sequence of the client's private data [p₁, . . . , pₙ], and D does not reveal the information of P. Test(D,x) returns true if the input x is one of the client's private data pᵢ with some probability. It is called a filter because given Test(D,⋅) by the client, the full node is able to test whether a transaction contains an account x that the client is interested in (belongs to P) and forwards it accordingly. But the full node is not fully certain about it as the test contains some false positives, thus giving the client some privacy. In an embodiment the privacy-preserving filter may be a Bloom filter or a Cuckoo filter.

The thin client publishes the privacy-preserving filter along with the setup transaction setup transaction Tₛ, for example by sending the privacy preserving filter and the setup transaction to the full node and by broadcasting setup transaction (and/or the refund transaction) onto the blockchain network. The full node may verify whether the setup transaction is valid, for example, that the setup transaction does not double-spend any transactions used as its input; and/or that the input of the accepted refund transaction corresponds to the setup transaction (e.g. that the hash is correct and/or the input amount is sufficient).

In a fourth operation, after the transaction forwarding criteria is set-up, the full node F starts forwarding transactions—and the corresponding proofs that are included in the blockchain ledger—to the thin client C.

For each forwarded transaction Txᵢ, the full node F expects the thin client C to reply with an update transaction Tᵤⁱ signed by the thin client C. The update transaction takes the setup transaction Tₛ as input and updates the output to send ∈+i×δ to the full node and the remaining σ−∈−(i×δ) back to the thin client, where S is the reward of forwarding one transaction and i is an integer representing the current count of forwarded transactions.

In a fifth operation, the transaction forwarding and micropayment channel is aborted. The transaction forwarding and micropayment channel can be aborted by any party (e.g., thin client C or full node F) at any time. For example, the thin client C may abort if the forwarded transaction does not contain a valid proof (i.e., the transaction forwarding/micropayment channel is closed by the thin client). The full node F may abort if the thin client C does not reply with an update transaction (i.e., the transaction forwarding/micropayment channel is closed by the full node). The transaction forwarding/micropayment channel may also closed by the full node F by signing and publishing the latest update transaction to claim the reward ∈+k×δ, or if time elapses after the lock time t. In the latter case, all deposit goes back to the thin client C.

In a sixth operation, if the deposit σ is all consumed, the thin client C needs to establish a new micropayment channel with the full node, and thus returns to the first operation described above.

In an embodiment, after the refund transaction Tᵣ becomes effective by the second operation, each update transaction Tᵤⁱ updates the balances by increasing the output to the full node F by corresponding reward δ and decreasing the output to the thin client C by the same reward δ. The full node F needs to claim its reward δ by publishing the latest signed update transaction before the lock time t expires.

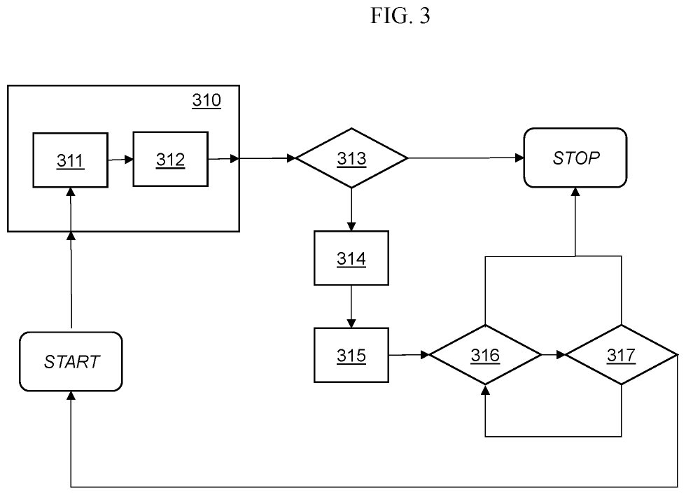

FIG. 3 illustrates a method according to an embodiment of the present invention.

To begin, the thin client initiates the establishment of a micropayment channel with a full node (operation 310). To initiate such establishment, the thin client initializes a setup transaction (operation 311) and sends a refund transaction Tᵣ to the full node (operation 312).

The setup transaction may take the thin client's deposit as an input and outputs a signature. The signature may be a 2-out-of-2 multi-signature of the thin client and the full node.

The refund transaction takes the setup transaction as an input (e.g., the setup transaction hash) and outputs a bootstrap service fee (e.g., a small amount of the deposit) to the full node and outputs the remaining deposit back to the thin client.

The refund transaction output may have a time lock. The time lock specifies to the blockchain that the refund transaction will only be valid after a certain amount of time. The refund transaction may be pre-signed by the thin client.

After receiving the refund transaction, the full node demines whether to serve the thin client (operation 313).

If the full node determines to serve the thin client, it replies by signing the refund transaction and sends the signed refund transaction back to the thin client (operation 314).

If the full node determines not to serve the thin client, it can abort the process (operation stop)

The thin client then sets up the transaction forwarding criteria by sending a privacy-preserving filter which can be used by the full node to filter the transactions on behalf of the thin client (operation 315). Along with the filter, the thin client publishes the setup transaction created in operation 311.

After the setup, the full node starts forwarding transactions and the corresponding proofs that they are included in the blockchain ledger to the thin client (operation 316).

In response to each forwarded transaction, the thin client replies to the full node with an update transaction signed by the thin client (operation 317).

The update transaction takes the setup transaction as its input and updates the output to send bootstrap fee plus a transaction fee the full node and the remaining deposit (i.e., the deposit less the bootstrap and transaction fee) back to the thin client, where the transaction fee is the reward of forwarding one transaction multiplied by the current transaction count.

The channel can be aborted by any party if the forwarded transaction does not contain a valid proof (close by the thin client) or the thin client does not reply with an update transaction (close by the full node) (operation stop). The channel is closed by the full node by signing and publishing the latest update transaction to claim the reward (which is the bootstrap fee plus the final transaction fee), or closed if the lock time elapses. In the latter case, the entire deposit goes back to the thin client.

If the deposit is all consumed, the thin client needs to establish a new micropayment channel with the full node (operation start).

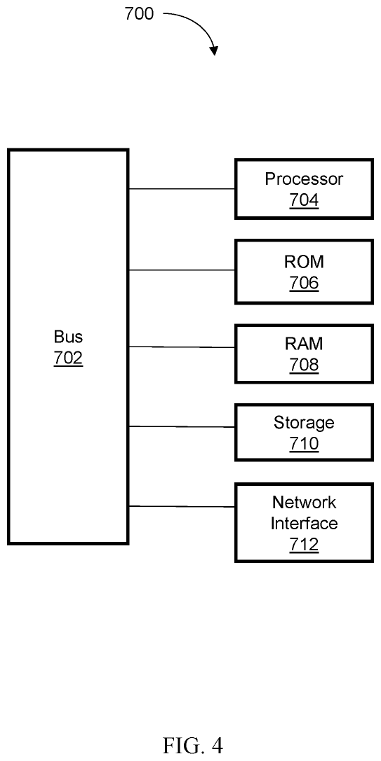

FIG. 4 is a block diagram of a processing system according to an embodiment. The processing system 700 can be used to implement the protocols, devices, mechanism, systems and methods described above. The processing system 700 includes a processor 704, such as a central processing unit (CPU) of a computing device or a distributed processor system. The processor 704 executes processor executable instructions comprising embodiments of the system for performing the functions and methods described above. In embodiments, the processor executable instructions are locally stored or remotely stored and accessed from a non-transitory computer readable medium, such as storage 710, which may be a hard drive, cloud storage, flash drive, etc. Read Only Memory (ROM) 706 includes processor executable instructions for initializing the processor 704, while the random-access memory (RAM) 708 is the main memory for loading and processing instructions executed by the processor 704. The network interface 712 may connect to a wired network or cellular network and to a local area network or wide area network, such as the Internet.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for supporting transaction forwarding to a thin client of a blockchain network performed by a node of the blockchain network, the method comprising:
receiving a refund transaction from the thin client, the refund transaction comprising a service bootstrap fee;
determining whether to provide transaction forwarding support to the thin client in response to receiving the refund transaction;
based upon determining to provide transaction forwarding support to the thin client, signing the refund transaction and sending the signed refund transaction to the thin client to establish a micropayment channel;
receiving a transaction filter from the thin client;
locating a blockchain transaction from a blockchain ledger and its corresponding proof that it is included in the ledger;
sending the located blockchain transaction and the corresponding proof to the thin client; and
receiving an update transaction from the thin client, the update transaction comprising an updated service fee and being signed by the thin client.

2. The method according to claim 1,
wherein the update transaction is one of a plurality of update transactions received from the thin client, each being received individually and successively,
wherein each of the update transactions increases the updated service fee over a prior updated service fee, and
wherein the method further comprises, in response to receiving each of the update transactions, locating, and sending to the thin client, another blockchain transaction from the blockchain ledger and its corresponding proof that it is included in the ledger.

3. The method according to claim 2 further comprising:
determining whether to close the micropayment channel and to stop supporting transaction forwarding;
based upon determining to close the micropayment channel and to stop supporting transaction forwarding, signing and publishing a most recently received one of the update transactions; and
collecting the updated service fee corresponding to the signed and published one of the update transactions.

4. The method according to claim 1, wherein the refund transaction is signed by the thin client, and was created based upon having a setup transaction as an input, and has as its outputs the service bootstrap fee for the node and a remaining deposit for the thin client.

5. The method according to claim 4, the method further comprising receiving the setup transaction as a published transaction on the blockchain network, the setup transaction being received after sending the signed refund transaction to the thin client.

6. The method according to claim 5, wherein the setup transaction was created based upon having a deposit from the thin client as an input, and the setup transaction having as an output a multi-signature of the thin client and the node.

7. The method according to claim 4,
wherein the update transaction was created based upon having the setup transaction as an input, and has as its output the updated service fee for the node and an updated remaining deposit for the thin client, and
wherein the updated service fee comprises the service bootstrap service fee and a multiple of a single transaction forwarding fee.

8. The method according to claim 1,
wherein the refund transaction has a time lock, and
wherein the method further comprises:
determining whether the time lock has expired;
upon determining that the time lock has expired, closing the micropayment channel and stopping support of transaction forwarding.

9. The method according to claim 1, further comprising receiving a rating on performance of transaction forwarding support.

10. A node of a blockchain network comprising a processor and a memory, the memory comprising processor executable instructions that, when executed by the processor, cause the processor to perform the following operations for supporting transaction forwarding to a thin client:
receiving a refund transaction from the thin client, the refund transaction comprising a service bootstrap fee;
determining whether to provide transaction forwarding support to the thin client in response to receiving the refund transaction;
based upon determining to provide transaction forwarding support to the thin client, signing the refund transaction and sending the signed refund transaction to the thin client to establish a micropayment channel;
receiving a transaction filter from the thin client;
locating a blockchain transaction from a blockchain ledger and its corresponding proof that it is included in the ledger;
sending the located blockchain transaction and the corresponding proof to the thin client; and
receiving an update transaction from the thin client, the update transaction comprising an updated service fee and being signed by the thin client.

11. The node according to claim 10,
wherein the update transaction is one of a plurality of update transactions individually and successively receivable from the thin client,
wherein each of the update transactions is configured to increase the updated service fee over a prior updated service fee, and
wherein the processor executable instructions, when executed by the processor, cause the processor to perform the following operations: in response to receiving each of the update transactions, locating, and sending to the thin client, another blockchain transaction from the blockchain ledger and its corresponding proof that it is included in the ledger.

12. The node according to claim 10, wherein the processor executable instructions, when executed by the processor, cause the processor to perform the following operations:
determining whether to close the micropayment channel and to stop supporting transaction forwarding;
based upon determining to close the micropayment channel and to stop supporting transaction forwarding, signing and publishing a most recently received one of the update transactions; and
collecting the updated service fee corresponding to the signed and published one of the update transactions.

13. The node according to claim 1, wherein the refund transaction is signed by the thin client, and was created based upon having a setup transaction as an input, and has as its outputs the service bootstrap fee for the node and a remaining deposit for the thin client.

14. A non-transitory computer readable medium comprising processor executable instructions that, when executed by a processor, cause the processor to perform the following operations for supporting transaction forwarding to a thin client:
receiving a refund transaction from the thin client, the refund transaction comprising a service bootstrap fee;
determining whether to provide transaction forwarding support to the thin client in response to receiving the refund transaction;
based upon determining to provide transaction forwarding support to the thin client, signing the refund transaction and sending the signed refund transaction to the thin client to establish a micropayment channel;
receiving a transaction filter from the thin client;
locating a blockchain transaction from a blockchain ledger and its corresponding proof that it is included in the ledger;
sending the located blockchain transaction and the corresponding proof to the thin client; and
receiving an update transaction from the thin client, the update transaction comprising an updated service fee and being signed by the thin client.

15. The non-transitory computer readable medium according to claim 14,
wherein the update transaction is one of a plurality of update transactions individually and successively receivable from the thin client,
wherein each of the update transactions is configured to increase the updated service fee over a prior updated service fee, and
wherein the processor executable instructions, when executed by the processor, cause the processor to perform the following operations: in response to receiving each of the update transactions, locating, and sending to the thin client, another blockchain transaction from the blockchain ledger and its corresponding proof that it is included in the ledger.
